(19) United States
(12) Patent Application Publication
(10) Pub. No.: US 2017/0162114 A1
(43) Pub. Date: Jun. 8, 2017

(54) DISPLAY DEVICE AND METHOD FOR DRIVING SAME

(71) Applicant: JOLED INC., Tokyo (JP)

(72) Inventor: Shinya ONO, Osaka (JP)

(73) Assignee: JOLED INC., Tokyo (JP)

(21) Appl. No.: 15/321,363

(22) PCT Filed: Jun. 24, 2015
(86) PCT No.: PCT/JP2015/003176

§ 371 Date: Dec. 22, 2016

(30) Foreign Application Priority Data
Jun. 27, 2014 (JP) 2014-132873

(51) Int. Cl. G09G 3/3233

(52) U.S. Cl. CPC G09G 3/3233; G09G 2320/0233; G09G 2300/0814; G09G 2300/0866; G09G 2330/028; G09G 2300/0426

(57) ABSTRACT

An organic EL display device includes: a plurality of pixels each of which includes an organic EL element that emits light according to a supplied pixel current Iₚᵢₓ, a drive transistor that supplies the pixel current Iₚᵢₓ to the organic EL element, and a holding capacitor connected between a gate and a source of the drive transistor; and a control unit that, in a display state of causing the organic EL element to emit light in a part of the plurality of pixels and changing a voltage of the holding capacitor to a threshold voltage of the drive transistor in another part of the plurality of pixels, applies a drain voltage of the drive transistor of a pixel in the other part independently of the drain voltage of the drive transistor of a pixel in the part.

### TECHNICAL FIELD

The present invention relates to a display device having a plurality of pixels and a method for driving the same.

### BACKGROUND ART

As display devices that use current-driven light emitting elements, display devices using organic electroluminescent (EL) elements are known. Organic EL display devices using organic EL elements which emit light are optimal for thinner devices as no backlight required for liquid crystal display devices is necessary. Organic EL display devices also have unlimited viewing angle. Organic EL display devices are therefore expected to be in practical use as next-generation display devices.

For example, Patent Literature (PTL) 1 discloses a structure for realizing higher-resolution pixels by improving power lines in an active matrix display device.

### CITATION LIST

### Patent Literature

### [PTL 1]

Japanese Unexamined Patent Application Publication No. 2008-65199

### SUMMARY OF INVENTION

### Technical Problem

However, such a display device that compensates the threshold voltage of each drive transistor and emits light may have display unevenness, i.e. a decrease in display uniformity.

In view of this, the present disclosure provides a display device that can prevent a decrease in display uniformity and a method for driving the same.

### Solution to Problem

A display device according to one aspect of the present disclosure is a display device including: a plurality of pixels each of which includes a light emitting element that emits light according to a supplied current, a drive transistor that supplies the current to the light emitting element, and a holding capacitor connected between a gate and a source of the drive transistor; and a control unit that, in a display state of causing the light emitting element to emit light in a part of the plurality of pixels and changing a voltage of the holding capacitor to a threshold voltage of the drive transistor in an other part of the plurality of pixels, applies a drain voltage of the drive transistor of a pixel in the other part independently of the drain voltage of the drive transistor of a pixel in the part.

### Advantageous Effects of Invention

With the display device, etc. according to the present disclosure, a decrease in display uniformity can be prevented.

### BRIEF DESCRIPTION OF DRAWINGS

FIG. 1 is a block diagram illustrating the schematic structure of an organic EL display device according to an embodiment.

FIG. 2 is a circuit diagram illustrating the circuit structure of a pixel in the organic EL display device according to the embodiment.

FIG. 3 is a timing chart illustrating the operation of the pixel in the organic EL display device according to the embodiment.

FIG. 4A is a diagram illustrating the state of the pixel in a Vth detection period in FIG. 3.

FIG. 4B is a diagram illustrating the state of the pixel in a light emission period in FIG. 3.

FIG. 5 is a graph illustrating the I-V characteristics of a drive transistor.

FIG. 6 is a diagram illustrating the display state of the organic EL display device according to the embodiment, where (a) is a timing chart illustrating the operation of the organic EL display device and (b) is a diagram schematically illustrating the state of a display area at time t20 in (a),

FIG. 7 is a circuit diagram illustrating the circuit structure of a pixel in an organic EL display device according to a comparative example.

FIG. 8 is a diagram illustrating the state of the pixel in a Vth detection period in the organic EL display device according to the comparative example.

FIG. 9 is a diagram schematically illustrating the layout of a second VDD line and a RESET line in the organic EL display device according to the embodiment.

FIG. 10 is a circuit diagram illustrating the circuit structure of a pixel in an organic EL display device according to Variation 1.

FIG. 11 is a circuit diagram illustrating the circuit structure of a pixel in an organic EL display device according to Variation 2.

FIG. 12 is a circuit diagram illustrating the circuit structure of a pixel in an organic EL display device according to Variation 3.

FIG. 13 is a circuit diagram illustrating the circuit structure of a pixel in an organic EL display device according to Variation 4.

FIG. 14 is an appearance diagram of a thin flat television including a display device according to the present disclosure.

### DESCRIPTION OF EMBODIMENTS

The following describes a display device and a driving method according to one aspect of the present disclosure in detail, with reference to drawings. In the following, description detailed more than necessary may be omitted. For example, detailed description of well-known matters or repeated description of the substantially same structures may be omitted. This is to avoid unnecessarily redundant description and facilitate the understanding of a person skilled in the art.

The accompanying drawings and the following description are provided to help a person skilled in the art to fully understand the present disclosure, and are not intended to limit the subject matter defined in the appended claims. For example, the numerical values, structural elements, arrangement and connection of the structural elements, etc. shown in the following embodiment are mere examples, and do not limit the scope of the present disclosure. Of the structural elements in the embodiment described below, the structural elements not recited in any one of the independent claims representing the broadest concepts are described as optional structural elements. The drawings are schematics, and are not necessarily precise illustrations. The following describes an organic EL display device using organic EL elements as light emitting elements, as one aspect of a display device according to the present disclosure.

### Embodiment

An organic EL display device according to this embodiment is described in detail below.

### [1. Structure of Organic EL Display Device]

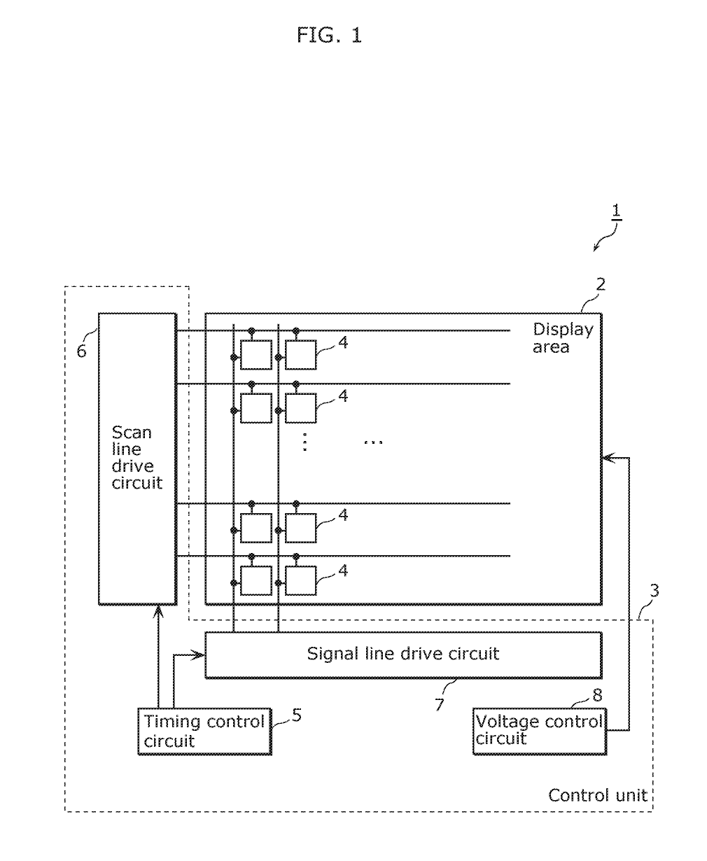

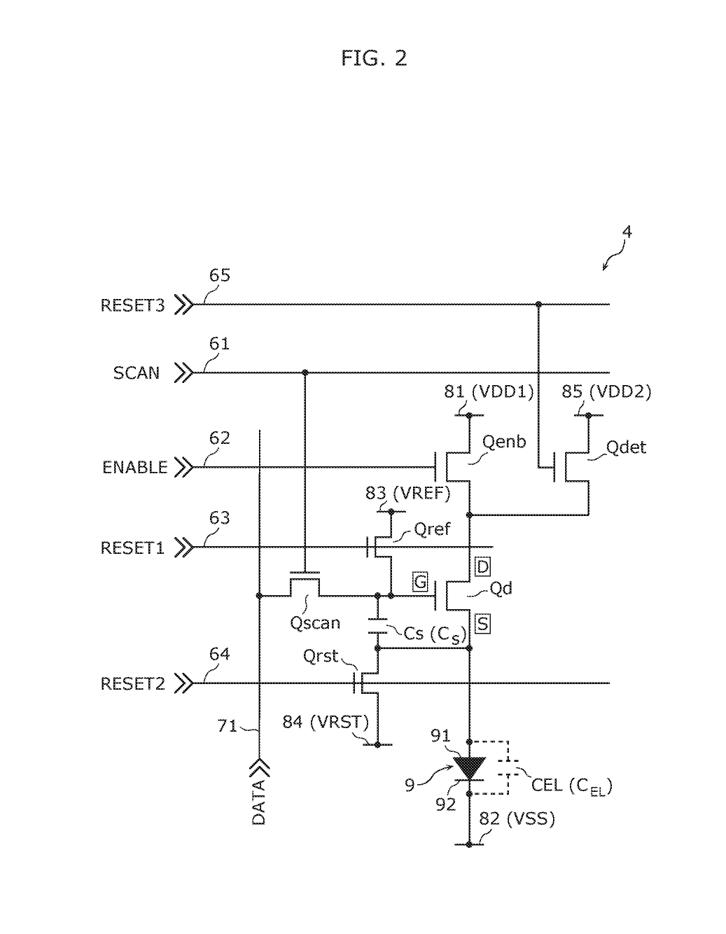

The structure of the organic EL display device according to this embodiment is described first, with reference to FIGS. 1 and 2. FIG. 1 is a block diagram illustrating the schematic structure of the organic EL display device according to this embodiment. FIG. 2 is a circuit diagram illustrating the circuit structure of a pixel in the organic EL display device according to this embodiment.

An organic EL display device 1 illustrated in FIG. 1 includes a display area 2 and a control unit 3. The display area 2 has the below-mentioned pixels 4 arranged in a matrix. The control unit 3 performs various controls on the plurality of pixels 4 arranged in the display area 2, and includes a timing control circuit 5, a scan line drive circuit 6, a signal line drive circuit 7, and a voltage control circuit 8. A plurality of pixels 4 arranged in correspondence with the same scan line are hereafter referred to as “display line” as appropriate.

The timing control circuit 5 performs, for example, synchronization between the scan line drive circuit 6 and the signal line drive circuit 7 and timing control on the operation of the organic EL display device 1 per frame.

The scan line drive circuit 6 drives each scan line in the display area 2 based on control signals from the timing control circuit 5. In detail, the scan line drive circuit 6 outputs a SCAN signal, an ENABLE signal, and RESET1 to RESET3 signals to each pixel 4 at least in units of display lines, based on a vertical synchronization signal and a horizontal synchronization signal. In the example of the pixel illustrated in FIG. 2, these signals are output to a SCAN line 61, an ENABLE line 62, and RESET lines 63 to 65, and used to control on and off of the connected transistors (switches).

The signal line drive circuit 7 drives each signal line (a DATA line 71 in FIG. 2) in the display area 2 based on control signals from the timing control circuit 5. In detail, the signal line drive circuit 7 outputs, to each pixel 4, a signal voltage DATA indicating the luminance of the pixel 4, based on a video signal and a horizontal synchronization signal. The signal voltage DATA is output to the DATA line 71 in FIG. 2, and used to designate the luminance of the connected pixel 4.

The voltage control circuit 8 supplies various power voltages to the display area 2. In the example of the pixel illustrated in FIG. 2, these power voltages are VDD1 (positive power voltage), VDD2 (positive power voltage), VSS (negative power voltage), VREF, and VRST, and are each supplied to the pixel 4 via a power line. The terms “positive power voltage” and “negative power voltage” here do not mean a higher power voltage and a lower power voltage with respect to GND, but simply mean voltages in the relationship “(positive power voltage)>(negative power voltage)”,

The organic EL display device 1 may have, for example, a central processing unit (CPU), a storage medium such as read only memory (ROM) storing a control program, working memory such as random access memory (RAM), and a communication circuit, although not illustrated. For example, the signal voltage DATA may be generated by the CPU executing the control program.

### [2. Circuit Structure of Pixel]

The circuit structure of the pixel 4 illustrated in FIG. 2 is described next.

The pixel 4 includes an organic EL element 9 that emits light according to a supplied current, a drive transistor Qd that supplies the current (pixel current) to the organic EL element 9, and a holding capacitor Cs connected between the gate and source of the drive transistor Qd. The organic EL element 9 emits light at the luminance corresponding to the signal voltage DATA supplied via the DATA line 71. The pixel 4 also includes the drive transistor Qd, a transistor Qscan, a transistor Qref, a transistor Qrst, a transistor Qenb (first switch), and a transistor Qdet (second switch). The pixel 4 is connected with the SCAN line 61, the ENABLE line 62, the RESET line 63, the RESET line 64, the RESET line 65 (control lines), and the DATA line 71, and also connected with a VREF line 83, a first VDD line 81 (first power line), a VSS line 82 (common line), a VRST line 84, and a second VDD line 85 (second power line) as power lines.

The VREF line 83 is a power line for supplying a reference voltage VREF (e.g. 3 V) based on which the threshold voltage of the drive transistor Qd is detected. The first VDD line 81 is a power line supplied with the positive power voltage VDD1 (e.g. 20 V), for supplying the current (pixel current) for causing the organic EL element 9 to emit light. The VSS line 82 is a power line supplied with the negative power voltage VSS (e.g. 0 V) and connected to a cathode 92 of the organic EL element 9. The VRST line 84 is a power line supplied with the voltage VRST (e.g. −5 V), for resetting the voltages of the organic EL element 9 and holding capacitor Cs. The second VDD line 85 is a power line supplied with the positive power voltage VDD2 (e.g. 20 V or 10 V), for supplying a current (threshold detection current) for detecting the threshold voltage of the drive transistor Qd.

Thus, the organic EL display device 1 according to this embodiment includes the first VDD line 81 and the second VDD line 85 as power lines for supplying positive power voltages to the plurality of pixels 4.

For example, each of the first VDD line 81 and second VDD line 85 extends in the pixel column arrangement direction (i.e. the row direction) so as to correspond to each display line in the display area 2. In other words, the plurality of first VDD lines 81 arranged in the display area 2 are separate from each other in the display area 2. Likewise, the plurality of second VDD lines 85 arranged in the display area 2 are separate from each other in the display area 2. Moreover, the plurality of first VDD lines 81 and plurality of second VDD lines 85 arranged in the display area 2 are in parallel with each other. Meanwhile, the layout of the first VDD lines 81 and second VDD lines 85 outside the display area 2 is not limited. For example, the plurality of first VDD lines 81 arranged in the display area 2 may be connected to each other outside the display area 2, or be separate from each other outside the display area 2. The same applies to the plurality of second VDD lines 85 arranged in the display area 2.

The plurality of first VDD lines 81 may be formed like meshes in the display area 2.

Let Vgpeak be the maximum voltage of the gate of the drive transistor Qd, and Vth be the threshold voltage of the drive transistor Qd. The voltage VDD1 of the first VDD line 81 and the voltage VDD2 of the second VDD line 85 are set as follows, to cause the drive transistor Qd to operate in a saturated region:
VDD1>Vgpeak−Vth
VDD2>VREF−Vth
VDD1>VDD2 can be set from Vgpeak>VREF.

Hence, the first VDD line 81 can supply the current (pixel current) in the below-mentioned light emission operation. Moreover, the second VDD line 85 can supply the current (threshold detection current) for detecting the threshold voltage of the drive transistor Qd in the below-mentioned threshold voltage compensation operation. By setting VDD1>VDD2, power consumption in the Vth detection operation can be reduced.

The organic EL element 9 emits the amount of light corresponding to the current supplied from the drive transistor Qd. The organic EL element 9 has a cathode 92 connected to the VS8 line 82, and an anode 91 connected to the source of the drive transistor Qd.

The drive transistor Qd is a voltage-driven drive element that controls the supply of current to the organic EL element 9, and passes the current (pixel current) through the organic EL element 9 to cause the organic EL element 9 to emit light. In detail, the drive transistor Qd has a gate connected to a first electrode of the holding capacitor Cs, and a source connected to a second electrode of the holding capacitor Cs and the anode 91 of the organic EL element 9. The drive transistor Qd can thus pass the current (pixel current) corresponding to the voltage held in the holding capacitor Cs, through the organic EL element 9. In other words, the organic EL display device 1 can cause the organic EL element 9 to emit light at the luminance corresponding to the voltage held in the holding capacitor Cs by the light emission operation.

The threshold voltage of the drive transistor Qd may vary among the pixels 4 due to an initial distribution at the time of formation of the TFT substrate provided with the drive transistor Qd or a temporal threshold voltage shift. The effect of such variation can be suppressed by the threshold voltage compensation operation. The threshold voltage compensation operation is an operation of setting, in the holding capacitor Cs in each pixel 4, the voltage obtained by adding the voltage corresponding to the signal voltage DATA to the voltage equivalent to the threshold voltage of the corresponding drive transistor Qd.

The light emission operation and the threshold voltage compensation operation will be described in detail later.

The holding capacitor Cs holds the threshold voltage of the drive transistor Qd, and further holds the signal voltage DATA for which the threshold voltage of the drive transistor Qd has been compensated using the held threshold voltage and the signal voltage DATA supplied from the DATA line 71. In detail, the second electrode of the holding capacitor Cs is connected to a node connecting the source (the VSS line 82 side) of the drive transistor Qd and the anode 91 of the organic EL element 9. The first electrode of the holding capacitor Cs is connected to the gate of the drive transistor Qd. The first electrode of the holding capacitor Cs is also connected to the VREF line 83 via the transistor Qref.

The transistor Qscan switches the state between the DATA line 71 for supplying the signal voltage DATA and the first electrode of the holding capacitor Cs, between conduction and nonconduction. In detail, the transistor Qscan is a switching transistor that has one of a drain and source connected to the DATA line 71, the other one of the drain and source connected to the first electrode of the holding capacitor Cs, and a gate connected to the SCAN line 61. In other words, the transistor Qscan has a function of writing the voltage corresponding to the signal voltage DATA supplied via the DATA line 71 to the holding capacitor Cs.

The transistor Qref switches the state between the VREF line 83 for supplying the reference voltage VREF and the first electrode of the holding capacitor Cs, between conduction and nonconduction. In detail, the transistor Qref is a switching transistor that has one of a drain and source connected to the VREF line 83, the other one of the drain and source connected to the first electrode of the holding capacitor Cs, and a gate connected to the RESET line 63. In other words, the transistor Qref has a function of supplying the reference voltage (VREF) to the first electrode of the holding capacitor Cs (the gate of the drive transistor Qd).

The transistor Qrst switches the state between the second electrode of the holding capacitor Cs and the VRST line 84, between conduction and nonconduction. In detail, the transistor Qrst is a switching transistor that has one of a drain and source connected to the VRST line 84, the other one of the drain and source connected to the anode 91 of the organic EL element 9 and the second electrode of the holding capacitor Cs, and a gate connected to the RESET line 64. In other words, the transistor Qrst has a function of supplying the reset voltage (VRST) to the anode 91 of the organic EL element 9 and the second electrode of the holding capacitor Cs (the source of the drive transistor Qd).

The transistor Qenb switches the state between the first VDD line 81 and the drain of the drive transistor Qd, between conduction and nonconduction. In detail, the transistor Qenb is a switching transistor that has one of a drain and source connected to the first VDD line 81 (VDD1), the other one of the drain and source connected to the drain of the drive transistor Qd, and a gate connected to the ENABLE line 62. In the light emission operation of the pixel 4, i.e. when the drive transistor Qd supplies the current (pixel current) to the organic EL element 9, the transistor Qenb is turned on to cause conduction between the first VDD line 81 and the drain of the drive transistor Qd.

The transistor Qdet switches the state between the second VDD line 85 and the drain of the drive transistor Qd, between conduction and nonconduction. In detail, the transistor Qdet is a switching transistor that has one of a drain and source connected to the second VDD line 85 (VDD2), the other one of the drain and source connected to the drain of the drive transistor Qd, and a gate connected to the RESET line 65. In the threshold voltage compensation operation of the pixel 4, the transistor Qdet is turned on to cause conduction between the second VDD line 85 and the drain of the drive transistor Qd.

With the structure of the pixel 4 described above, the organic EL display device 1 can compensate the threshold voltage of the drive transistor Qd accurately. The organic EL display device 1 can accordingly prevent a decrease in display uniformity. This mechanism be described in detail later in the description of the operation.

Although the following description assumes that the plurality of switching transistors (the transistors Qscan, Qref, Qrst, Qenb, and Qdet) in the pixel 4 are n-type TFTs, this is not a limitation. The plurality of switching transistors may be p-type TFTs. Alternatively, the plurality of switching transistors may be a combination of n-type and p-type TFTs,

### [3. Operation of Organic EL Display Device]

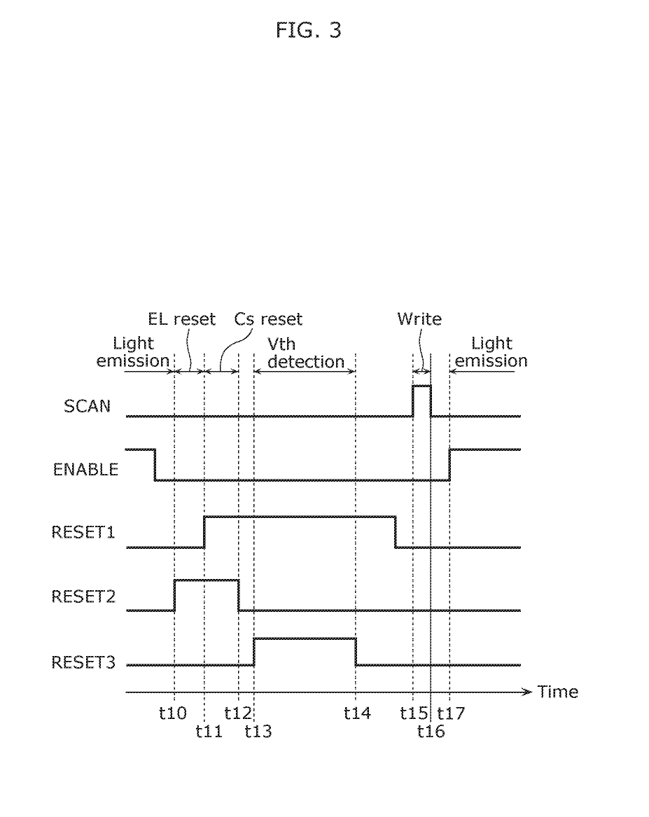

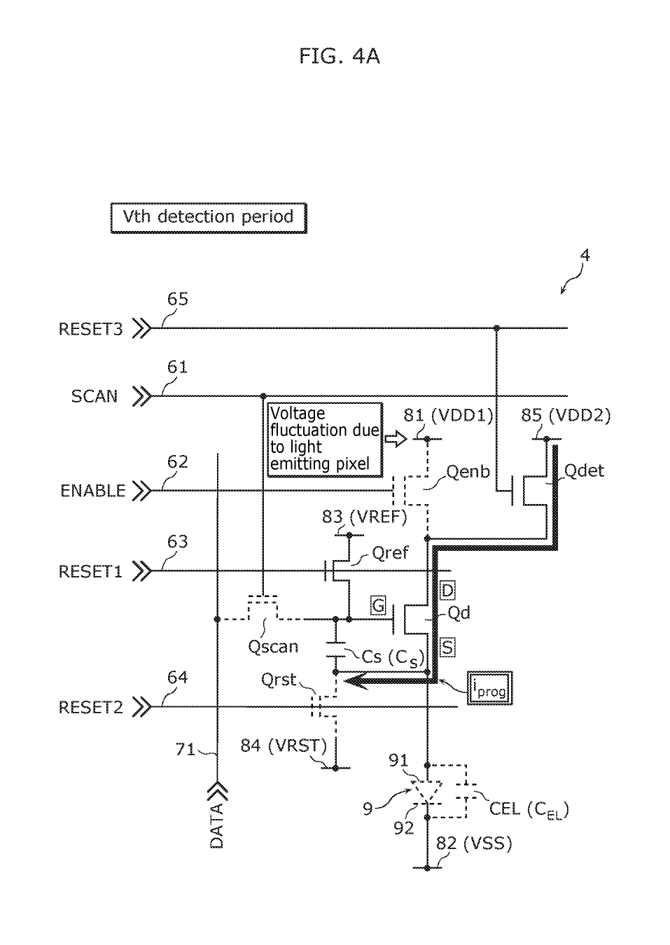

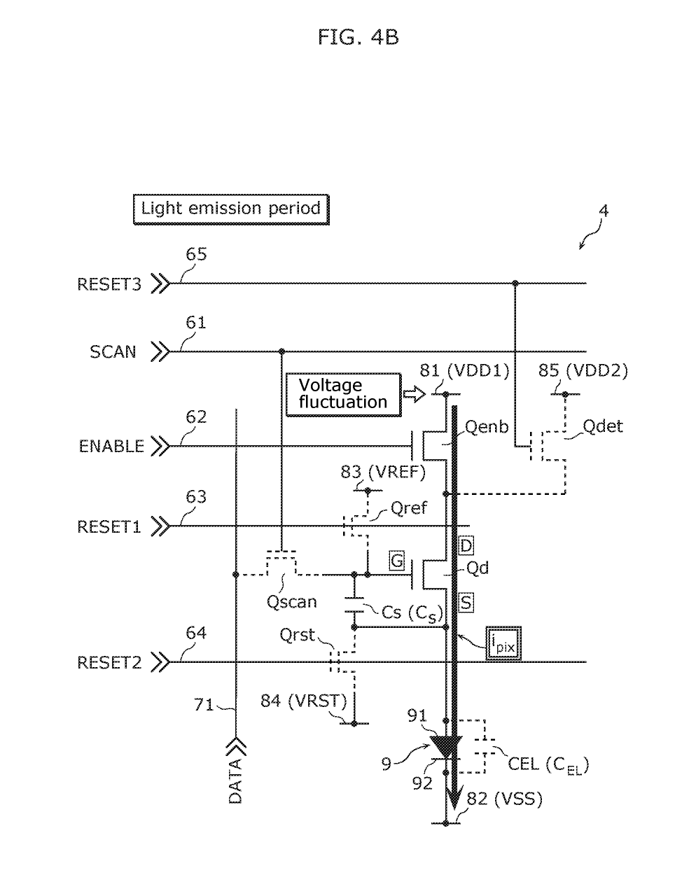

The operation of the organic EL display device 1 having the aforementioned structure is described below, with reference to FIGS. 3, 4A, and 4B. Each operation described below is executed by the control unit 3. FIG. 3 is a timing chart illustrating the operation of the pixel 4 in the organic EL display device 1 according to this embodiment. In FIG. 3, the SCNA signal supplied to the SCAN line 61, the ENABLE signal supplied to the ENABLE line 62, the RESET1 signal supplied to the RESET line 63, the RESET2 signal supplied to the RESET line 64, and the RESET3 signal supplied to the RESET line 65 are illustrated in this order from above. FIG. 4A is a diagram illustrating the state of the pixel 4 in a Vth (threshold) detection period in FIG. 3. FIG. 4B is a diagram illustrating the state of the pixel 4 in a light emission period in FIG. 3.

### <Time t10 to t11: EL Reset Period>

In an EL reset period from time t10 to t11 in FIG. 3, only the voltage level of the RESET2 signal is HIGH, to bring only the transistor Qrst into conduction.

As a result, the charge held in the capacitive component CEL of the organic EL element 9 can be reset. Thus, the source voltage of the drive transistor Qd is promptly set to the voltage VRST of the VRST line 84.

### <Time t11 to t12: Cs Reset Period>

Next, at time t11, the voltage level of the RESET1 signal changes from LOW to HIGH. Hence, at time t11, the transistor Qref is brought into conduction (on). As a result, in the period up to time t12, the charge held in the holding capacitor Cs can be reset. Thus, the gate voltage of the drive transistor Qd is set to the voltage VREF of the VREF line 83.

Although the RESET2 signal rises at time t10 and the RESET1 signal rises at time t11 in the timing chart in FIG. 3, the charge held in the holding capacitor Cs can be reset in the period up to time t12 even in the case where the RESET2 signal rises at time t11 and the RESET1 signal rises at time t10.

Here, the gate-source voltage of the drive transistor Qd at time t12 (Cs reset period end time) needs to be set to such an initial voltage that ensures an initial drain current necessary for the threshold voltage compensation operation performed after the Cs reset period. In detail, the initial voltage needs to a voltage that is higher than the threshold voltage Vth of the drive transistor Qd and does not cause the organic EL element 9 to emit light. Accordingly, the potential difference between the voltage VREF of the VREF line 83 and the voltage VRST of the VRST line 84 is set to a voltage higher than the maximum threshold voltage of the drive transistor Qd (VREF−VRST>Vth). In addition, the voltages VREF and VRST are set to such voltages that satisfy the following two expressions so that the organic EL element 9 does not emit light, where VEL is the forward-current threshold voltage of the organic EL element 9.
VRST<VSS+VEL
VREF<VSS+VEL+Vth

Subsequently, at time t12, the voltage level of the RESET2 signal changes from HIGH to LOW, to bring the transistor Qrst out of conduction (off).

### <Time t13 to t14: Vth Detection Period>

Next, at time t13, the voltage level of the RESET3 signal changes from LOW to HIGH, to bring the transistor Qdet into conduction (on).

As a result, the threshold detection current i_{prog} starts to flow from the drain to source of the drive transistor Qd, as illustrated in FIG. 4A. Thus, at time t13, the threshold detection current i_{prog} starts to flow from the second VDD line 85, so that charging the holding capacitor Cs and the capacitive component CEL of the organic EL element 9 starts. Subsequently, as the holding capacitor Cs and the capacitive component CEL are being charged, the source voltage of the drive transistor Qd increases. In detail, the source voltage of the drive transistor Qd changes so that the gate-source voltage of the drive transistor Qd reaches the threshold voltage Vth of the drive transistor Qd.

After this, at time t14, the voltage level of the RESET3 signal changes from HIGH to LOW, to bring the transistor Qdet out of conduction (off). As a result, the supply of the threshold detection current i_{prog} is stopped. It is desirable that, at time 14, the threshold detection current i_{prog} is a sufficiently low current level and is less than the maximum value of the pixel current iₚᵢₓ in the light emission period. Accordingly, W/L, which is a size parameter of each of Qenb and Qdet, may be lower in Qdet than in Qenb. This reduces the area necessary for the pixel circuit. Here, W is the channel width of the TFT, and L is the channel length of the TFT.

After this, in the period of time t14 to t15, the voltage level of the RESET1 signal changes from HIGH to LOW, to bring the transistor Qref out of conduction (off). As a result, the voltage of the holding capacitor Cs is held. In other words, the threshold voltage Vth of the drive transistor Qd detected in the period of time t14 to t15 is held as the voltage of the holding capacitor Cs.

Thus, the organic EL display device 1 performs the threshold voltage compensation operation by turning the transistors Qscan, Qenb, and Qrst off and the transistors Qref and Qdet on. In detail, the organic EL display device 1 detects the threshold voltage of the drive transistor Qd, by supplying the voltage VDD2 to the drain of the drive transistor Qd in a state where the voltage of the gate of the drive transistor Qd is fixed and the source of the drive transistor Qd is floating.

The threshold voltage detected by the threshold voltage compensation operation may be different from the original threshold voltage due to various conditions (the length of the Vth detection period, a voltage drop of power voltage, etc.). Accordingly, hereafter the threshold voltage detected by the threshold voltage compensation operation may be denoted by Vth_m and the original threshold voltage by Vth_t to distinguish them. The original threshold voltage is, for example, determined by the device parameters of the drive transistor Qd.

Alternatively, the RESET1 signal may fall at time t14 and the RESET3 signal fall in the period of time t14 to t15.

### <Time t15 to t16: Write Period>

Next, at time t15, the voltage level of the SCAN signal changes from LOW to HIGH, to bring the transistor Qscan into conduction (on). As a result, the first electrode of the holding capacitor Cs is supplied with the signal voltage DATA from the DATA line 71.

After this, at time t16, the voltage level of the SCAN signal changes from HIGH to LOW, to bring the transistor Qscan out of conduction (off). As a result, in addition to the threshold voltage Vth_m of the drive transistor Qd detected in the Vth detection period, the voltage obtained by capacitance-dividing the potential difference between the signal voltage DATA (VDATA in the expression) and the voltage VREF of the VREF line 83 by the capacitance C_{EL} Of the capacitive component CEL of the organic EL element 9 and the capacitance Cₛ of the holding capacitor Cs is held in the holding capacitor Cs. The gate-source voltage Vgs of the drive transistor is defined by the following Expression 1.

$$\begin{matrix}[ Math . 1 ] & \\ Vgs = \frac{{C}_{EL}}{{C}_{S} + {C}_{EL}} ( VDATA - VREF ) + Vth\_m . & ( Expression 1 )\end{matrix}$$

### <Time t17 Onward: Light Emission Period>

Next, at time t17, the voltage level of the ENABLE signal changes from LOW to HIGH, to bring the transistor Qenb into conduction (on). As a result, the pixel current iₚᵢₓ starts to flow from the drain to source of the drive transistor Qd, as Illustrated in FIG. 4B. The drive transistor Qd thus supplies the pixel current iₚᵢₓ from the first VDD line 81 to the organic EL element 9, according to the voltage held in the holding capacitor Cs. This causes the organic EL element 9 to emit light.

The pixel current iₚᵢₓ is defined by the following Expression 2.

$$\begin{matrix}[ Math . 2 ] & \\ {i}_{pix} = \frac{β}{2} {( Vgs - Vth\_t )}^{2} . & ( Expression 2 )\end{matrix}$$

Substituting Expression 1 into this expression yields the pixel current iₚᵢₓ defined by the following Expression 3.

$$\begin{matrix} [ Math . 3 ] & \\ {i}_{pix} = \frac{β}{2} {( \frac{{C}_{EL}}{{C}_{S} + {C}_{EL}} ( VDATA - VREF ) + Vth\_m - Vth\_t )}^{2} . & ( Expression 3 )\end{matrix}$$

Here, β is a coefficient that depends on the mobility μ, gate insulating film capacitance Cox, channel length L, and channel width W of the drive transistor Qd, and is defined by the following Expression 4.

β=(W/L)·μ·Cox (Expression 4).

As is clear from Expression 3, when the threshold voltage Vth_m detected by the threshold voltage compensation operation is closer to the original threshold voltage Vth_t, the organic EL display device 1 can compensate the threshold voltage of the drive transistor Qd more accurately to emit light.

By the aforementioned operation, the organic EL display device 1 according to this embodiment can compensate the threshold voltage of the drive transistor Qd in each pixel 4 and emit light.

### [4. Mechanism for Preventing Decrease in Display Uniformity]

As mentioned above, the threshold voltage Vth_m detected by the threshold voltage compensation operation needs to be as close to the original threshold voltage Vth_t as possible, in order to accurately compensate the threshold voltage of the drive transistor to emit light. However, the threshold voltage Vth_m detected by the threshold voltage compensation operation may vary due to various conditions. In other words, the detection accuracy of the threshold voltage Vth_m may vary. In such a case, there is a possibility of a decrease in display uniformity of the display area 2 even when the same signal voltage DATA is supplied to all pixels 4.

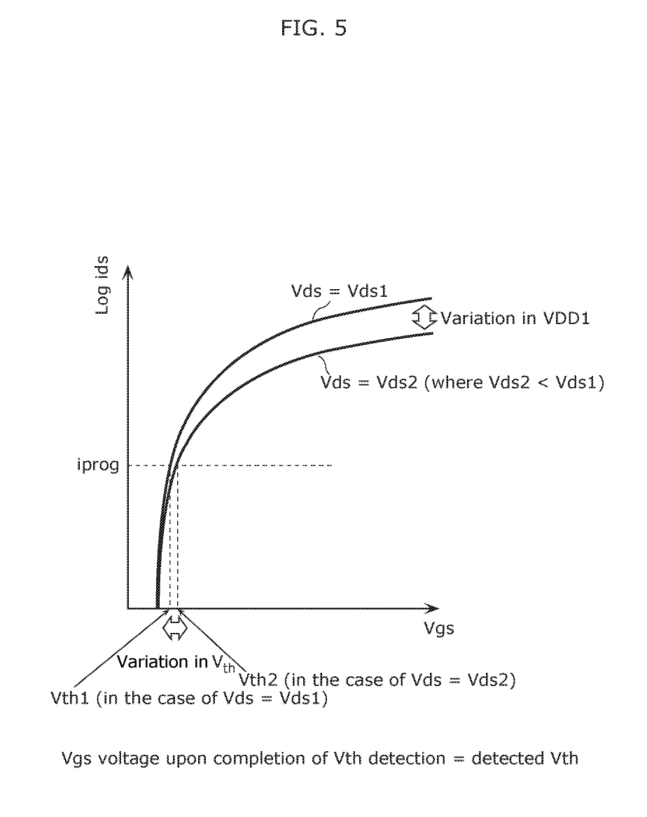

In view of this, the organic EL display device 1 according to this embodiment prevents a decrease in display uniformity by uniformizing the detection accuracy of the threshold voltage Vth_m detected by the threshold voltage compensation operation. This mechanism is described below, with reference to FIGS. 5 to 8 in addition to the foregoing FIGS. 4A and 4B.

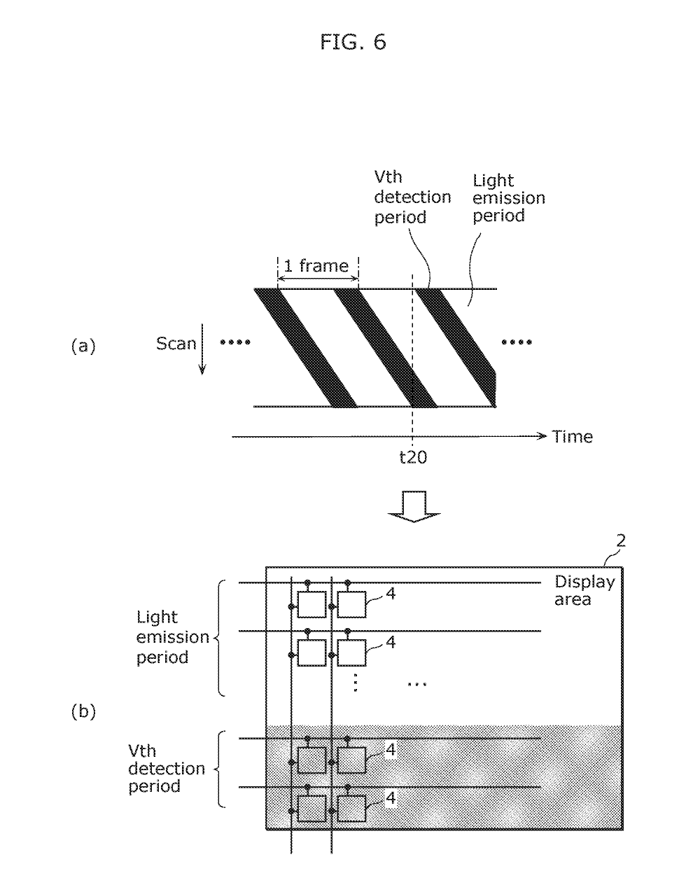

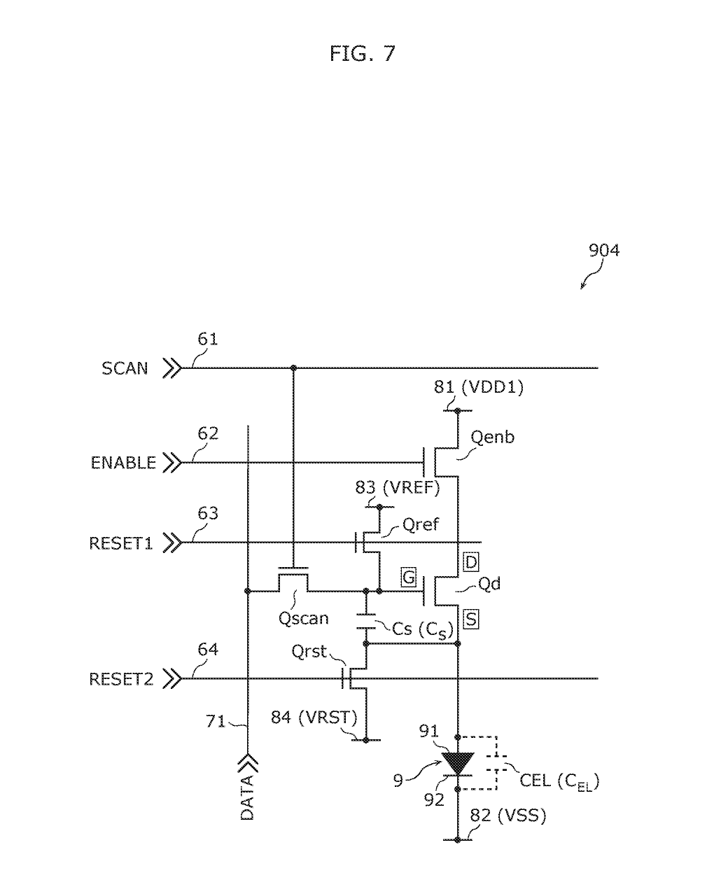

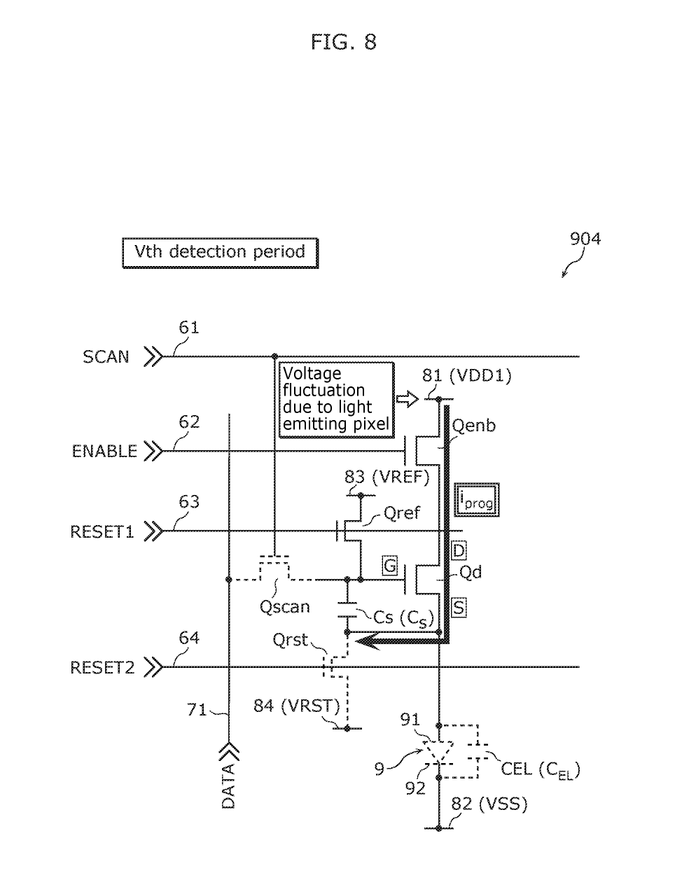

FIG. 5 is a graph illustrating the I-V characteristics of the drive transistor Qd. FIG. 6 is a diagram illustrating the display state of the organic EL display device 1 according to this embodiment, where (a) is a timing chart illustrating the Vth detection and light emission operation of the organic EL display device 1 and (b) is a diagram schematically illustrating the state of the display area at time t20 in (a). FIG. 7 is a circuit diagram illustrating the circuit structure of a pixel 904 in an organic EL display device according to a comparative example. FIG. 8 is a diagram illustrating the state of the pixel 904 in the Vth detection period in the organic EL display device according to the comparative example.

The organic EL display device according to the comparative example is similar to the organic EL display device 1 according to this embodiment, but differs in that the second VDD line 85 and the transistor Qdet are not included, and the transistor Qenb causes conduction between the first VDD line 81 and the drain of the drive transistor Qd to supply the threshold detection current i_{prog} in the threshold voltage compensation operation.

### [4-1. Effect of Drain Voltage of Drive Transistor on Detection Accuracy of Threshold Voltage]

FIG. 5 illustrates the drain current Ids with respect to the gate-source voltage Vgs of the drive transistor Qd in the case where the drain-source voltage Vds of the drive transistor Qd is Vds1 and in the case where Vds is Vds2 (where Vds2<Vds1).

As illustrated in FIG. 5, the drain current Ids of the drive transistor Qd not only depends on the gate-source voltage Vgs of the drive transistor Qd but also depends on the drain-source voltage Vds of the drive transistor Qd.

Here, the threshold voltage Vth_m of the drive transistor Qd which is the voltage held in the holding capacitor Cs after the Vth detection period (time t15 onward in FIG. 3) is the gate-source voltage Vgs of the drive transistor Qd at the end of the Vth detection period (time t15 in FIG. 3).

The threshold voltage Vth_m detected in the Vth detection period thus depends on the drain-source voltage Vds of the drive transistor Qd. Therefore, to uniformize the detection accuracy of the threshold voltage in the display area 2, the drain voltage of the drive transistor Qd in the threshold voltage compensation operation needs to be uniformized in the display area 2.

### [4-2. Display State of Display Area]

For example, the organic EL display device 1 according to this embodiment performs the light emission operation and the threshold voltage compensation operation on the display lines sequentially (row sequential), as illustrated in (a) in FIG. 6. The control unit 3 thus drives and scans the display lines in the display area 2 sequentially (row sequential). Therefore, in the organic EL display device 1, the operation (light emission operation) of the light emission period (from t17 in FIG. 3) for causing the organic EL element 9 to emit light is performed in a part of the plurality of pixels 4 (part of the display lines), and the operation (threshold voltage compensation operation) of the Vth detection period (t13 to t14 in FIG. 3) for changing the voltage of the holding capacitor Cs to the threshold voltage of the drive transistor Qd is performed in the other part of the plurality of pixels 4 (the other part of the display lines), as illustrated in (b) in FIG. 6. In other words, in the organic EL display device 1, a part of the plurality of pixels 4 (part of the display lines) is in the state illustrated in FIG. 4B, and the other part of the plurality of pixels 4 (the other part of the display lines) is in the state illustrated in FIG. 4A.

Here, the voltage of the first VDD line 81 fluctuates relatively widely due to the pixel current iₚᵢₓ flowing through the pixel 4 in the light emission period in FIG. 4B. In other words, the voltage of the first VDD line 81 fluctuates relatively widely due to a voltage drop by the pixel current iₚᵢₓ. This may cause the following problem in the pixel 904 in the comparative example illustrated in FIG. 7.

In the pixel 904 in the comparative example, the transistor Qenb is on in the Vth detection period, as a result of which the threshold detection current i_{prog} flows from the first VDD line 81 and the threshold voltage Vth_m of the drive transistor Qd is detected as illustrated in FIG. 8.

The detection accuracy of the threshold voltage Vth_m detected here is, however, affected by the drain voltage of the drive transistor Qd as mentioned above. In the pixel 904 in the comparative example, the drain of the drive transistor Qd and the first VDD line 81 are in conduction with each other in the Vth detection period. The detection accuracy of the threshold voltage Vth_m is therefore affected by the voltage of the first VDD line 81.

Since the voltage of the first VDD line 81 fluctuates relatively widely as mentioned above, the pixel 904 in the comparative example has a problem in that the detection accuracy of the threshold voltage Vth_m fluctuates relatively widely depending on the display pattern of the display area.

In this embodiment, on the other hand, in a display state of causing a part of the plurality of pixels 4 to perform the light emission operation and the other part of the plurality of pixels 4 to perform the threshold voltage compensation operation, the control unit 3 applies the drain voltage of the drive transistor Qd of each pixel 4 in the other part independently of the drain voltage of the drive transistor Qd of each pixel 4 in the part.

This suppresses the fluctuation of the drain voltage of the drive transistor Qd in the Vth detection period, with it being possible to uniformize the detection accuracy of the threshold voltage Vth_m. The organic EL display device 1 according to this embodiment thus prevents a decrease in display uniformity.

In detail, the organic EL display device 1 according to this embodiment includes the first VDD line 81 (first power line) and the second VDD line 85 (second power line) for supplying power voltages to the plurality of pixels 4. Each pixel 4 includes the transistor Qenb (first switch) provided in the current path of the current (pixel current iₚᵢₓ) supplied to the organic EL element 9 via the first VDD line 81, and the transistor Qdet (second switch) for switching the state between the second VDD line 85 and the drain of the drive transistor Qd between conduction and nonconduction.

In more detail, the control unit 3 turns the switch Qenb on and the switch Qdet off in each pixel 4 in the part and turns the switch Qenb off and the switch Qdet on in each pixel 4 in the other part, to apply the drain voltage of the drive transistor Qd of each pixel 4 in the other part independently of the drain voltage of the drive transistor Qd of each pixel 4 in the part.

Thus, the drain voltage of the drive transistor Qd in the Vth detection period is applied independently of the voltage of the first VDD line 81 affected by the light emission operation (such as a voltage drop by the pixel current iₚᵢₓ). The accuracy of the threshold voltage Vth_m detected by the threshold voltage compensation operation can be uniformized in this way.

The expression “applying the voltage independently” means that the change of one voltage is unlikely to affect the change of the other voltage. For example, in the case where one voltage changes from V11 to V12 (different from V11) by ΔV1, the other voltage remains unchanged at V21. Here, the other voltage may change from V21 to V22 by ΔV2 as long as the timing of the change differs from that of the voltage, that is, as long as their timings are irrelevant to each other. The relationship between V11 and V21 is not limited, and V11 and V21 may be different or the same.

### [5. Advantageous Effects]

As described above, the organic EL display device 1 according to this embodiment includes: a plurality of pixels 4 each of which includes an organic EL element 9 (light emitting element) that emits light according to a supplied pixel current iₚᵢₓ, a drive transistor Qd that supplies the pixel current iₚᵢₓ to the organic EL element 9, and a holding capacitor Cs connected between a gate and a source of the drive transistor Qd; and a control unit 3 that, in a display state of causing the organic EL element 9 to emit light in a part of the plurality of pixels 4 and changing a voltage of the holding capacitor Cs to a threshold voltage of the drive transistor Qd in an other part of the plurality of pixels 4, applies a drain voltage of the drive transistor Qd of a pixel 4 in the other part independently of the drain voltage of the drive transistor Qd of a pixel 4 in the part.

Thus, in the pixel 4 in which the voltage of the holding capacitor Cs is changed to the threshold voltage of the drive transistor Qd, the effect of the current (pixel current) flowing through the pixel 4 in which the organic EL element 9 is emitting light on the drain voltage of the drive transistor Qd can be reduced. The detection accuracy of the threshold voltage of the drive transistor Qd can be uniformized in this way. In other words, the dependence of the detection accuracy of the threshold voltage on the display pattern of the display area 2 or the position of the pixel 4 in the display area 2 can be suppressed. The organic EL display device 1 according to this embodiment can therefore prevent a decrease in display uniformity.

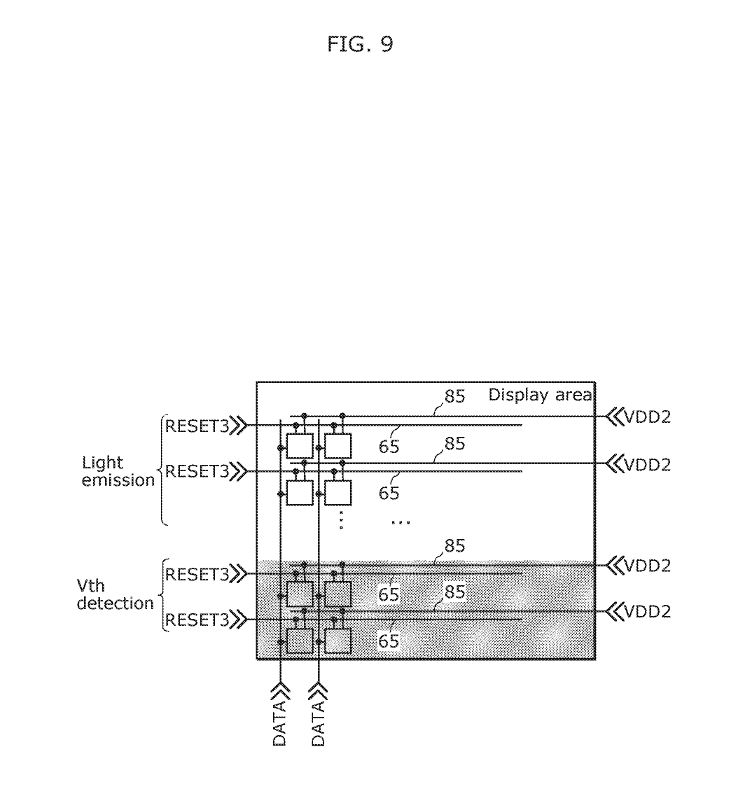

The second VDD line 85 may be provided for each display line (row) of the plurality of pixels 4. For example, the second VDD line 85 may be located as illustrated in FIG. 9. FIG. 9 is a diagram schematically illustrating the layout of the second VDD line 85 and RESET line 65 in the organic EL display device 1 according to this embodiment.

As illustrated in FIG. 9, the second VDD line 85 may be provided for each display line (row) of the plurality of pixels 4, in parallel with the RESET line 65 (control line) corresponding to the display line.

The RESET line 65 is a line that is provided for each display line of the plurality of pixels arranged in a matrix, to designate the timing of bringing the switch Qdet (second switch) into or out of conduction. The RESET line 65 is supplied with the RESET3 signal for turning on or off the transistor Qdet. The voltage of the RESET line 65 changes as the level of the RESET3 signal changes between HIGH and LOW.

Hence, in the case where the second VDD line 85 corresponding to a display line in which the threshold voltage compensation operation is being performed intersects, in a planar view, with the RESET line 65 whose voltage level changes from HIGH to LOW or from LOW to HIGH in the Vth detection period (time t13 to t14 in FIG. 3) of the display line, the second VDD line 85 constantly keeps supplying current because the plurality of pixels connected to the second VDD line 85 perform the Vth detection operation at different timings, which may make the voltage of the second VDD line 85 unstable. In such a case, there is a possibility of a decrease in display uniformity. In the case where the second VDD line 85 is in parallel with the RESET line 65, on the other hand, the pixels are connected to the second VDD line 85 in units of rows in the Vth detection period, and the current supplied by the second VDD line 85 decreases at the end of the Vth detection period. The voltage of the second VDD line 85 is stable in this case, so that a decrease in display uniformity caused by the threshold voltage compensation operation can be prevented.

In this embodiment, the drive transistor Qd is an n-type transistor, and the organic EL element 9 has an anode 91 connected to the source of the drive transistor Qd, and a cathode 92 connected to a VSS line 82 which is a common line provided in common to at least a part of the plurality of pixels 4.

Here, when a voltage (VSS) of the VSS line 82 is a reference voltage, a difference between the drain voltage (VDD2) of the drive transistor Qd and the reference voltage (VSS) in the threshold voltage compensation operation may be less than a difference between the drain voltage (VDD1) of the drive transistor Qd and the reference voltage (VSS) in the light emission operation.

Power consumption in the threshold voltage compensation operation can be reduced in this way.

### (Variation 1)

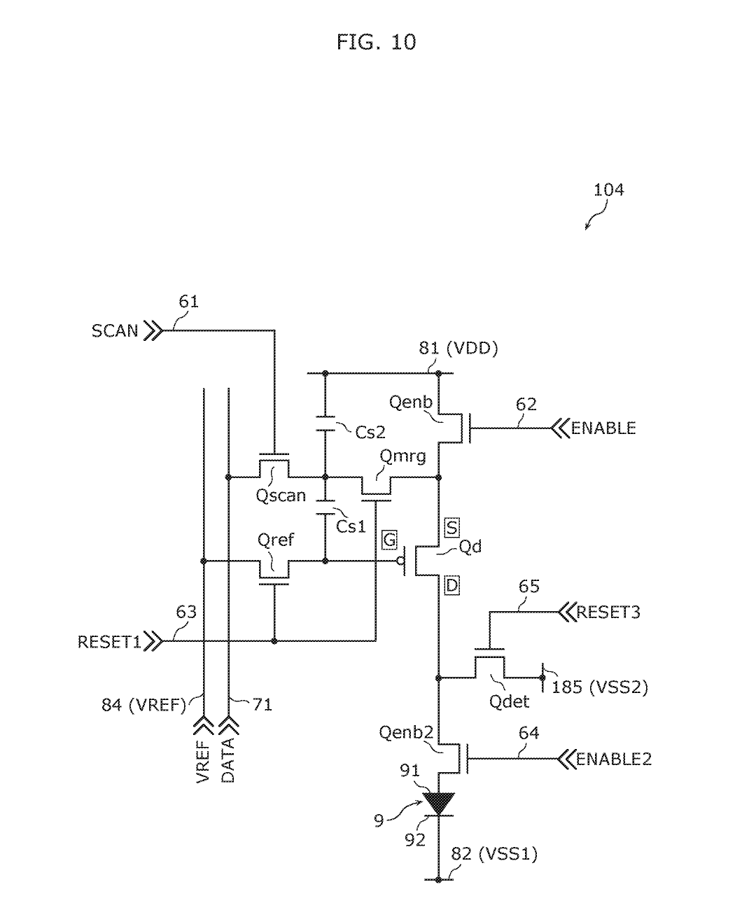

The pixel structure is not limited to the aforementioned structure, and any structure may be used as long as the drive transistor Qd is turned on in a state where the voltage of the gate of the drive transistor Qd is fixed and the source of the drive transistor Qd is floating in the threshold voltage compensation operation. For example, a structure illustrated in FIG. 10 is applicable. FIG. 10 is a circuit diagram illustrating the circuit structure of a pixel in an organic EL display device according to Variation 1.

In a pixel 104 illustrated in FIG. 10, the drive transistor Qd is a p-type transistor, and the organic EL element 9 has the anode 91 connected to the drain of the drive transistor Qd via a transistor Qenb2 and the cathode 92 connected to the VSS line 82 which is a common line provided in common to at least a part of the plurality of pixels 4. In this variation, the VSS line 82 (first power line) and a VSS line 185 (second power line) for supplying negative power voltages (VSS1, VSS2) to the plurality of pixels 104 are provided. Moreover, in this variation, VDD is supplied to the first VDD line 81 as a positive power voltage.

The organic EL display device including such a pixel 104 performs the threshold voltage compensation operation by turning the transistors Qscan, Qenb, and Qenb2 off and the transistors Qref, Qmrg, and Qdet on. In detail, the organic EL display device applies the drain voltage of the drive transistor Qd of the pixel 104 performing the threshold voltage compensation operation independently of the drain voltage of the drive transistor Qd of the pixel 104 performing the light emission operation, by turning the transistors Qenb and Qenb2 (first switch) on and the transistor Qdet (second switch) off in the pixel 104 performing the light emission operation and turning the transistor Qenb2 off and the transistor Qdet on in the pixel 104 performing the threshold voltage compensation operation.

The organic EL display device according to this variation thus achieves the same advantageous effects as the foregoing embodiment. In other words, the organic EL display device can prevent a decrease in display uniformity.

In detail, in the case where the VSS line 185 (second power line) and the transistor Qdet are not included, the drain voltage of the drive transistor Qd in the threshold voltage compensation operation depends on the voltage of the VSS line 82 (first power line). The voltage of the VSS line 82 fluctuates relatively widely due to the pixel current iₚᵢₓ flowing through the pixel 104 in the light emission period. There is thus a problem in that the detection accuracy of the threshold voltage Vth_m decreases due to the fluctuation of the drain voltage of the drive transistor Qd in the threshold voltage compensation operation.

On the other hand, the organic EL display device according to this variation includes the VSS line 185 (second power line) and the transistor Qdet, and applies the drain voltage of the drive transistor Qd of the pixel 104 performing the threshold voltage compensation operation independently of the drain voltage of the drive transistor Qd of the pixel 104 performing the light emission operation. In this way, the organic EL display device can uniformize the detection accuracy of the threshold voltage Vth_m, and therefore prevent a decrease in display uniformity.

Moreover, by setting VSS1<VSS2, power consumption in the Vth detection operation can be reduced.

### (Variation 2)

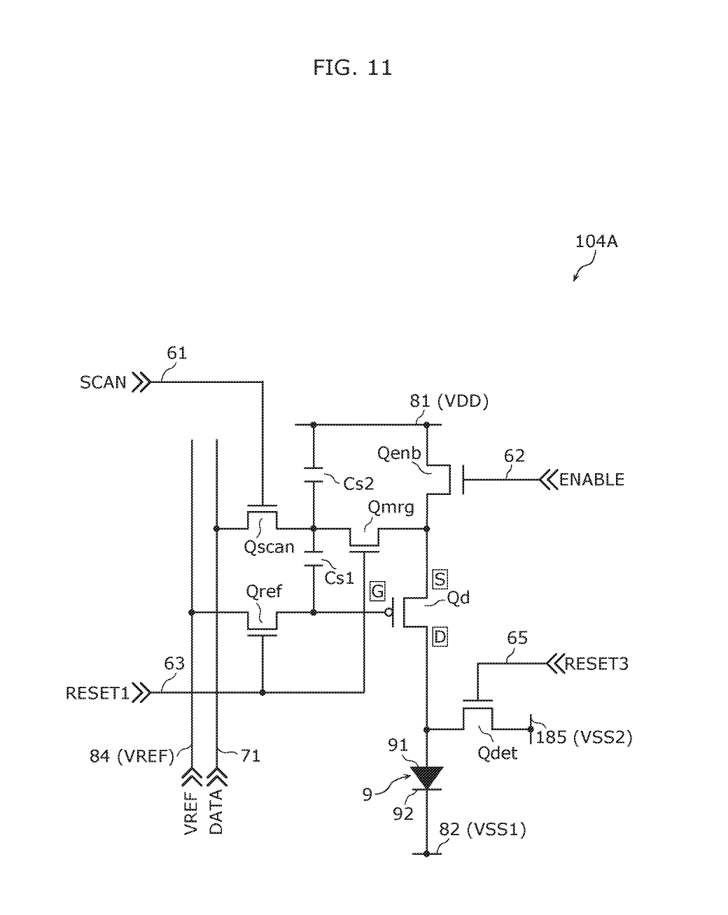

A structure illustrated in FIG. 11 is also applicable. FIG. 11 is a circuit diagram illustrating the circuit structure of a pixel in an organic EL display device according to Variation 2, where the transistor Qenb2 in Variation 1 is omitted by using the diode characteristics of the organic EL element 9.

In a pixel 104A illustrated in FIG. 11, the drive transistor Qd is a p-type transistor, and the organic EL element 9 has the anode 91 connected to the drain of the drive transistor Qd and the cathode 92 connected to the VSS line 82 which is a common line provided in common to at least a part of the plurality of pixels 4. In this variation, the VSS line 82 (first power line) and the VSS line 185 (second power line) for supplying negative power voltages (VSS1, VSS2) to the plurality of pixels 104A are provided. Moreover, in this variation, VDD is supplied to the first VDD line 81 as a positive power voltage.

The organic EL display device including such a pixel 104A performs the threshold voltage compensation operation by turning the transistors Qscan and Qenb off and the transistors Qref, Qmrg, and Qdet on. In detail, the organic EL display device applies the drain voltage of the drive transistor Qd of the pixel 104A performing the threshold voltage compensation operation independently of the drain voltage of the drive transistor Qd of the pixel 104A performing the light emission operation, by turning the transistor Qenb (first switch) on and the transistor Qdet (second switch) off in the pixel 104A performing the light emission operation and turning the transistor Qenb off and the transistor Qdet on in the pixel 104A performing the threshold voltage compensation operation.

The organic EL display device according to this variation thus achieves the same advantageous effects as the foregoing embodiment. In other words, the organic EL display device can prevent a decrease in display uniformity.

In detail, in the case where the VSS line 185 (second power line) and the transistor Qdet are not included, the drain voltage of the drive transistor Qd in the threshold voltage compensation operation depends on the voltage of the VSS line 82 (first power line). The voltage of the VSS line 82 fluctuates relatively widely due to the pixel current iₚᵢₓ flowing through the pixel 104A in the light emission period. There is thus a problem in that the detection accuracy of the threshold voltage Vth_m decreases due to the fluctuation of the drain voltage of the drive transistor Qd in the threshold voltage compensation operation.

On the other hand, the organic EL display device according to this variation includes the VSS line 185 (second power line) and the transistor Qdet, and applies the drain voltage of the drive transistor Qd of the pixel 104A performing the threshold voltage compensation operation independently of the drain voltage of the drive transistor Qd of the pixel 104A performing the light emission operation. In this way, the organic EL display device can uniformize the detection accuracy of the threshold voltage Vth_m, and therefore prevent a decrease in display uniformity.

Moreover, by setting VSS1>VSS2, the organic EL element 9 is inversely biased (anode voltage<cathode voltage). This suppresses the degradation of the organic EL element 9 over time.

### (Variation 3)

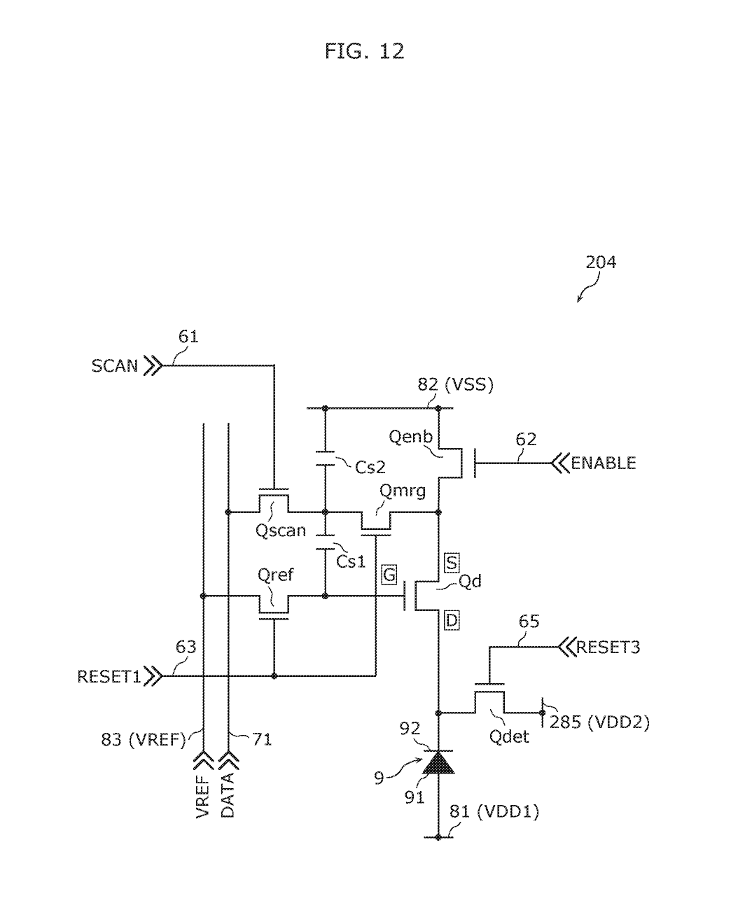

A pixel structure illustrated in FIG. 12 is also applicable. FIG. 12 is a circuit diagram illustrating the circuit structure of a pixel in an organic EL display device according to Variation 3.

In a pixel 204 illustrated in FIG. 12, the drive transistor Qd is an n-type transistor, and the organic EL element 9 has the cathode 92 connected to the drain of the drive transistor Qd and the anode 91 connected to the VSS line 82 which is a common line provided in common to at least a part of the plurality of pixels 204. In this variation, the first VDD line 81 (first power line) and a second VDD line 285 (second power line) for supplying positive power voltages (VDD1, VDD2) to the plurality of pixels 204 are provided.

The organic EL display device including such a pixel 204 performs the threshold voltage compensation operation by turning the transistors Qscan and Qenb off and the transistors Qref, Qmrg, and Qdet on, as in Variation 2. In detail, the organic EL display device applies the drain voltage of the drive transistor Qd of the pixel 204 performing the threshold voltage compensation operation independently of the drain voltage of the drive transistor Qd of the pixel 204 performing the light emission operation, by turning the transistor Qenb (first switch) on and the transistor Qdet (second switch) off in the pixel 204 performing the light emission operation and turning the transistor Qenb off and the transistor Qdet on in the pixel 204 performing the threshold voltage compensation operation.

The organic EL display device according to this variation thus achieves the same advantageous effects as the foregoing embodiment. In other words, the organic EL display device can prevent a decrease in display uniformity.

In detail, in the case where the second VDD line 285 (second power line) and the transistor Qdet are not included, the drain voltage of the drive transistor Qd in the threshold voltage compensation operation depends on the voltage of the first VDD line 81 (first power line). The voltage of the first VDD line 81 fluctuates relatively widely due to the pixel current iₚᵢₓ flowing through the pixel 204 in the light emission period. There is thus a problem in that the detection accuracy of the threshold voltage Vth_m decreases due to the fluctuation of the drain voltage of the drive transistor Qd in the threshold voltage compensation operation.

On the other hand, the organic EL display device according to this variation includes the second VDD line 285 (second power line) and the transistor Qdet, and applies the drain voltage of the drive transistor Qd of the pixel 204 performing the threshold voltage compensation operation independently of the drain voltage of the drive transistor Qd of the pixel 204 performing the light emission operation. In this way, the organic EL display device can uniformize the detection accuracy of the threshold voltage Vth_m, and therefore prevent a decrease in display uniformity.

### (Variation 4)

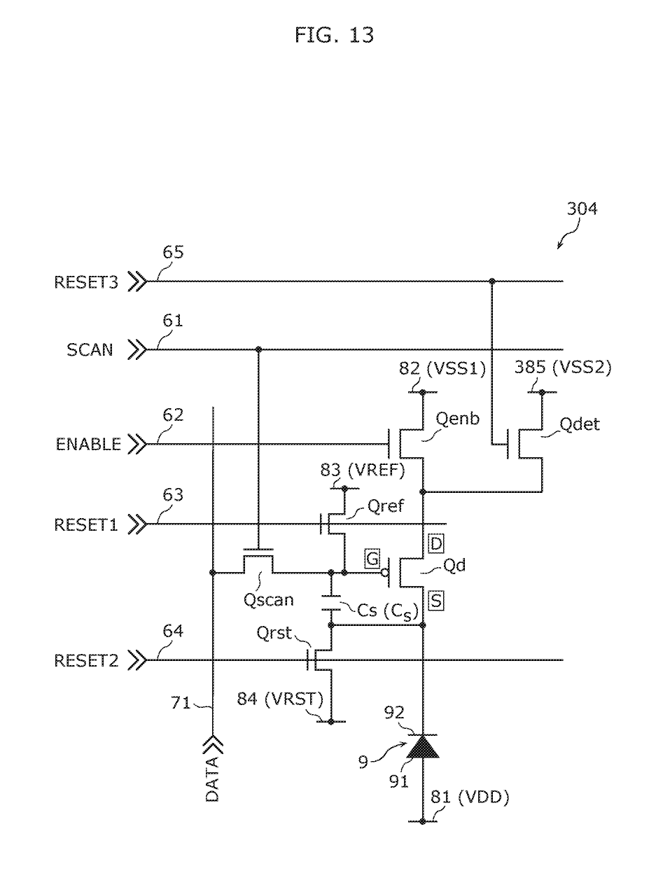

A pixel structure illustrated in FIG. 13 is also applicable. FIG. 13 is a circuit diagram illustrating the circuit structure of a pixel in an organic EL display device according to Variation 4.

In a pixel 304 illustrated in FIG. 13, the drive transistor Qd is a p-type transistor, and the organic EL element 9 has the cathode 92 connected to the source of the drive transistor Qd and the anode 91 connected to the first VDD line 81 which is a common line provided in common to at least a part of the plurality of pixels 304. In this variation, the VSS line 82 (first power line) and a VSS line 385 (second power line) for supplying negative power voltages (VSS1, VSS2) to the plurality of pixels 304 are provided. Moreover, in this variation, VDD is supplied to the first VDD line 81 as a positive power voltage.

The organic EL display device including such a pixel 304 performs the threshold voltage compensation operation by turning the transistors Qscan, Qenb, and Qrst off and the transistors Qref and Qdet on, as in the foregoing embodiment. In detail, the organic EL display device applies the drain voltage of the drive transistor Qd of the pixel 304 performing the threshold voltage compensation operation independently of the drain voltage of the drive transistor Qd of the pixel 304 performing the light emission operation, by turning the transistor Qenb (first switch) on and the transistor Qdet (second switch) off in the pixel 304 performing the light emission operation and turning the transistor Qenb off and the transistor Qdet on in the pixel 304 performing the threshold voltage compensation operation.

The organic EL display device according to this variation thus achieves the same advantageous effects as the foregoing embodiment. In other words, the organic EL display device can prevent a decrease in display uniformity.

In detail, in the case where the VSS line 385 (second power line) and the transistor Qdet are not included, the drain voltage of the drive transistor Qd in the threshold voltage compensation operation depends on the voltage of the VSS line 82 (first power line). The voltage of the VSS line 82 fluctuates relatively widely due to the pixel current iₚᵢₓ flowing through the pixel 304 in the light emission period. There is thus a problem in that the detection accuracy of the threshold voltage Vth_m decreases due to the fluctuation of the drain voltage of the drive transistor Qd in the threshold voltage compensation operation.

On the other hand, the organic EL display device according to this variation includes the VSS line 385 (second power line) and the transistor Qdet, and applies the drain voltage of the drive transistor Qd of the pixel 304 performing the threshold voltage compensation operation independently of the drain voltage of the drive transistor Qd of the pixel 304 performing the light emission operation. In this way, the organic EL display device can uniformize the detection accuracy of the threshold voltage Vth_m, and therefore prevent a decrease in display uniformity.

Suppose the voltage (VDD) of the first VDD line 81 is a reference voltage. Then, the difference between the drain voltage (VSS22) of the drive transistor Qd in the threshold voltage compensation operation and the reference voltage (VDD) may be less than the difference between the drain voltage (VSS1) of the drive transistor Qd in the light emission operation and the reference voltage (VDD).

Power consumption in the threshold voltage compensation operation can be reduced in this way.

### (Other Variations)

While the organic EL display device 1 according to the present disclosure has been described above, the present disclosure is not limited to the foregoing embodiment and variations.

For example, although the above describes the organic EL display device including the organic EL element 9 as a light emitting element as the display device according to the present disclosure, this is not a limitation, and any display device including a current-driven light emitting element may be used.

The present disclosure can be not only realized as such a display device, but also realized as a display device driving method including the processes executed by the display device as steps. A method for driving a display device according to one aspect of the present disclosure is a method for driving a display device including a plurality of pixels each of which includes: a light emitting element that emits light according to a supplied current; a drive transistor that supplies the current to the light emitting element; and a holding capacitor connected between a gate and a source of the drive transistor, the method including applying, in a display state of causing the light emitting element to emit light in a part of the plurality of pixels and changing a voltage of the holding capacitor to a threshold voltage of the drive transistor in an other part of the plurality of pixels, a drain voltage of the drive transistor of a pixel in the other part independently of the drain voltage of the drive transistor of a pixel in the part.

The display device may further include a first power line and a second power line that supply power voltages to the plurality of pixels, each of the plurality of pixels may further include: a first switch provided in a current path of the current supplied to the light emitting element via the first power line; and a second switch that switches a state between the second power line and a drain of the drive transistor between conduction and nonconduction, the method may include, in the stated order: causing the holding capacitor to hold a voltage corresponding to the threshold voltage of the drive transistor in a state where the first switch is off and the second switch is on, in the pixel in the part; causing the holding capacitor to hold a voltage obtained by compensating a signal voltage indicating luminance of the light emitting element by the threshold voltage in a state where the first switch is off and the second switch is off, in the pixel in the part; and causing the light emitting element to emit light by turning the first switch on and the second switch off, in the pixel in the part, and in the causing the holding capacitor to hold a voltage corresponding to the threshold voltage, the drain voltage of the drive transistor of the pixel in the other part may be applied independently of the drain voltage of the drive transistor of the pixel in the part.

The present disclosure can also be realized as a program for causing a computer to function as the characteristic control unit included in the display device, or a program for causing a computer to execute the characteristic steps included in the driving method. Such a program may be distributed via a computer-readable non-transitory recording medium such as CD-ROM (Compact Disc-Read Only Memory) or a communication network such as the Internet.

Other modifications obtained by applying various changes conceivable by a person skilled in the art to the embodiment and variations and any combinations of the structural elements and functions in the embodiment and variations without departing from the scope of the present disclosure are also included in the scope of the present disclosure.

### INDUSTRIAL APPLICABILITY

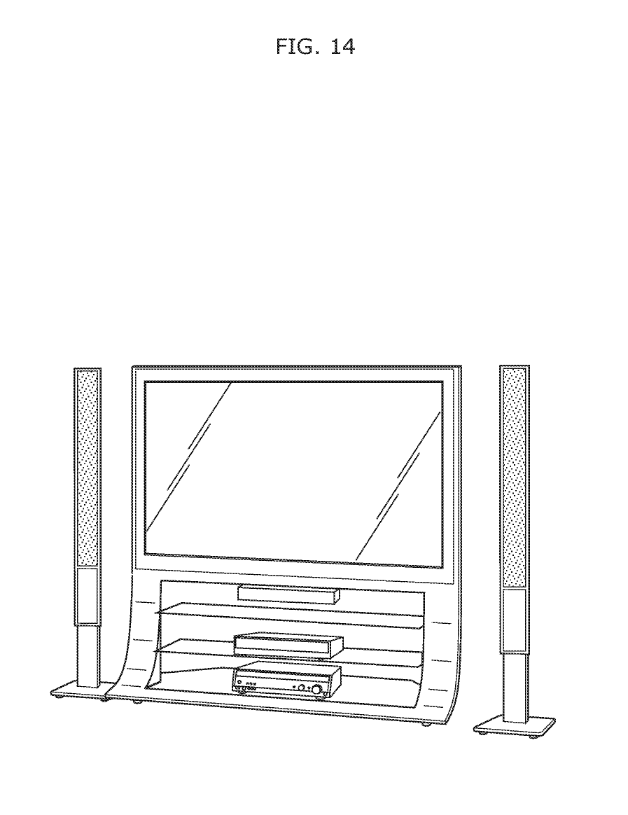

The present disclosure can be used for a display device, and particularly for a FPD display device such as a television illustrated in FIG. 14.

### REFERENCE SIGNS LIST

1 Organic EL display device
2 Display area
3 Control unit
4, 104, 104A, 204, 304, 904 Pixel
5 Timing control circuit
6 Scan line drive circuit
7 Signal line drive circuit
8 Voltage control circuit
9 Organic EL element
61 SCAN line
62 ENABLE line
63 to 65 RESET line
71 DATA line
81 First VDD line
82, 185, 385 VSS line
83 VREF line
84 VRST line
85, 285 Second VDD line
91 Anode
92 Cathode
Cs, Cs1, Cs2 Holding capacitor
CEL Capacitive component
Qd Drive transistor
Qdet, Qenb, Qenb2, Qmrg, Qref, Qrst, Qscan Transistor

1. A display device comprising:
a plurality of pixels each of which includes a light emitting element that emits light according to a supplied current, a drive transistor that supplies the current to the light emitting element, and a holding capacitor connected between a gate and a source of the drive transistor, and
a control unit configured to, in a display state of causing the light emitting element to emit light in a part of the plurality of pixels and changing a voltage of the holding capacitor to a threshold voltage of the drive transistor in an other part of the plurality of pixels, apply a drain voltage of the drive transistor of a pixel in the other part independently of the drain voltage of the drive transistor of a pixel in the part.

2. The display device according to claim 1, further comprising
a first power line and a second power line that supply power voltages to the plurality of pixels,
wherein each of the plurality of pixels further includes a first switch provided in a current path of the current supplied to the light emitting element via the first power line, and a second switch that switches a state between the second power line and a drain of the drive transistor between conduction and nonconduction.

3. The display device according to claim 2,
wherein the control unit is configured to, in the display state, apply the drain voltage of the drive transistor of the pixel in the other part independently of the drain voltage of the drive transistor of the pixel in the part, by turning the first switch on and the second switch off in the pixel in the part and turning the first switch off and the second switch on in the pixel in the other part.

4. The display device according to claim 2, further comprising
a control line that is provided for each row of the plurality of pixels arranged in a matrix, and designates a timing of bringing the second switch into or out of conduction,
wherein the second power line is provided for each row of the plurality of pixels, in parallel with the control line corresponding to the row.

5. The display device according to claim 2,
wherein each of the first switch and the second switch is a thin film transistor, and
the second switch has smaller W/L than the first switch, where W is a channel width of the thin film transistor and L is a channel length of the thin film transistor.

6. The display device according to claim 1,
wherein the drive transistor is an n-type transistor, and
the light emitting element has an anode connected to the source of the drive transistor, and a cathode connected to a common line provided in common to at least a part of the plurality of pixels.

7. The display device according to claim 1,
wherein the drive transistor is a p-type transistor, and
the light emitting element has a cathode connected to the source of the drive transistor, and an anode connected to a common line provided in common to at least a part of the plurality of pixels.

8. The display device according to claim 6,
wherein when a voltage of the common line is a reference voltage, a difference between the drain voltage of the drive transistor of the pixel in the other part and the reference voltage is less than a difference between the drain voltage of the drive transistor of the pixel in the part and the reference voltage in the display state.

9. The display device according to claim 1,
wherein the drive transistor is a p-type transistor, and
the light emitting element has an anode connected to a drain of the drive transistor, and a cathode connected to a common line provided in common to at least a part of the plurality of pixels.

10. The display device according to claim 1,
wherein the drive transistor is an n-type transistor, and
the light emitting element has a cathode connected to a drain of the drive transistor, and an anode connected to a common line provided in common to at least a part of the plurality of pixels.

11. The display device according to claim 1, further comprising
a first power line and a second power line that supply power voltages to the plurality of pixels,
wherein the light emitting element is an organic electroluminescent (EL) element,
each of the plurality of pixels further includes a second switch that switches a state between the second power line and a drain of the drive transistor between conduction and nonconduction, and
the first power line and the drain of the drive transistor are constantly connected via the organic EL element.

12. The display device according to claim 11,
wherein the control unit is configured to, in the display state, set an anode voltage of the light emitting element to be lower than a cathode voltage of the light emitting element in the pixel in the other part.

13. A method for driving a display device including a plurality of pixels each of which includes: a light emitting element that emits light according to a supplied current; a drive transistor that supplies the current to the light emitting element; and a holding capacitor connected between a gate and a source of the drive transistor, the method comprising
applying, in a display state of causing the light emitting element to emit light in a part of the plurality of pixels and changing a voltage of the holding capacitor to a threshold voltage of the drive transistor in an other part of the plurality of pixels, a drain voltage of the drive transistor of a pixel in the other part independently of the drain voltage of the drive transistor of a pixel in the part.

14. The method for driving a display device according to claim 13,
wherein the display device further includes a first power line and a second power line that supply power voltages to the plurality of pixels,
each of the plurality of pixels further includes: a first switch provided in a current path of the current supplied to the light emitting element via the first power line; and a second switch that switches a state between the second power line and a drain of the drive transistor between conduction and nonconduction,
the method comprises, in the stated order:
causing the holding capacitor to hold a voltage corresponding to the threshold voltage of the drive transistor in a state where the first switch is off and the second switch is on, in the pixel in the part;
causing the holding capacitor to hold a voltage obtained by compensating a signal voltage indicating luminance of the light emitting element by the threshold voltage in a state where the first switch is off and the second switch is off, in the pixel in the part; and
causing the light emitting element to emit light by turning the first switch on and the second switch off, in the pixel in the part, and
in the causing the holding capacitor to hold a voltage corresponding to the threshold voltage, the drain voltage of the drive transistor of the pixel in the other part is applied independently of the drain voltage of the drive transistor of the pixel in the part.
